(19) United States
(12) Patent Application Publication
(10) Pub. No.: US 2006/0219040 A1
(43) Pub. Date: Oct. 5, 2006

(54) Clamping device

(76) Inventor: Werner Petri, Erlangen (DE)

Correspondence Address: LUCAS & MERCANTI, LLP, 475 PARK AVENUE SOUTH, 15TH FLOOR, NEW YORK, NY, 10016, US

(21) Appl. No.: 10/567,054

(22) PCT Filed: Jul. 16, 2004
(86) PCT No.: PCT/EP04/07909

§ 371 Date: Feb. 2, 2006

(30) Foreign Application Priority Data
Aug. 16, 2003 (DE) 10337586.4

(51) Int. Cl. G05G 1/00

(52) U.S. Cl. 74/469

(57) ABSTRACT

The invention relates to a clamping device (1a) for a traction mechanism (2a). The clamping device (1a) is connected via a spring means (11a) to an actuating lever (10a) which can be adjusted between two end positions. The actuating lever (10a) can be adjusted automatically by means of an actuator (18) in conjunction with a controller (20).

### FIELD OF THE INVENTION

The present invention relates to a clamping device for a traction means of a traction mechanism which is used on internal combustion engines. The clamping device comprises a rotatably mounted roller which is supported by spring means and bears against the traction means in a fractionally locking fashion. The traction mechanism which is assigned to an internal combustion engine includes the drive and output of a starter generator. Furthermore, the present invention relates to a traction mechanism with a clamping device which includes an assembly which is connected to the traction mechanism and which is arranged so as to be pivotable about a pivot and is supported by a spring means which influences a prestressing force of the traction means.

### BACKGROUND OF THE INVENTION

Clamping devices of this previously described design are provided on internal combustion engines, for example, for driving a water pump, power steering system pump, air conditioning system compressor or other assemblies. Contemporary internal combustion engines also include a traction mechanism which can be referred to as a control drive, for driving the camshaft or plurality of camshafts. Preferably a continuous belt is provided as the traction means for these traction mechanisms. As far as possible slip-free drive is necessary for the functioning of the assemblies to be driven and in order to achieve a long service life of the traction means. Clamping devices in which preferably a roller which is embodied as a pulley preferably bears against the traction means under the action of a force.

A traction mechanism of this type is shown by DE 68 04 829 U. In this context, in order to achieve sufficient prestress of the traction means a generator of the internal combustion engine is pivotably arranged and supported by means of a threaded rod. The prestressing force of the traction means can be influenced by means of a helical spring which is assigned to a threaded sleeve, with the threaded rod having left-handed and right-handed threads. In order to mount the traction means, the sleeve is firstly turned until sufficient prestress of the traction means is set before the prestressed helical spring is connected to the threaded sleeve. In the operating position, when the traction means is extended the prestressed helical spring brings about automatic rotation of the sleeve, combined with pivoting of the generator, causing the traction means to be restressed. The traction means connects a first pulley, connected to the crankshaft of the internal combustion engine, and a second pulley, assigned to the generator. The pivotable generator at the same time assumes the function of the clamping device for the traction mechanism, with the known device being restricted exclusively to compensating an extended traction means.

### SUMMARY OF THE INVENTION

The object of the present invention is to implement a traction mechanism in which the prestressing of the traction means can be influenced as a function of operating states or operating parameters of the internal combustion engine or of an assembly to be driven.

This problem is achieved according to the invention by means of the features of claims 1 and 2.

The clamping device according to the invention as claimed in claim 1 comprises a pivotable roller lever on which the roller which is supported in a frictionally locking fashion on the traction means in the installation position is positioned. The roller lever is also connected to a spring means which brings about a connection between the roller lever and pivotable actuating lever. In order to adjust the actuating lever into at least two positions, an actuator is coupled to the actuating lever. In order to permit the actuating lever to pivot automatically as a function of an operating state or at least an operating parameter of the internal combustion engine, the actuator is connected to a controller. This measure is suitable in particular for a traction mechanism which includes the drive and output of a starter generator in which sufficient prestress of the traction means can be brought about with the clamping device for both operating states of the starter generator. In the traction mechanism, a reversal of torque occurs between the starting mode and the normal mode or a generator mode of the starter generator, and is associated with a change between the unloaded strand and the pulling strand, without a change in direction of the traction means.

In conventional traction mechanisms, the clamping device is assigned to the unloaded strand which, in the generator mode of the starter generator, becomes positioned in the traction means section between the pulley of the crankshaft and the last assembly to be driven when viewed from the crankshaft. In the starting mode of the starter generator, the clamping device is assigned to the pulling strand, with increased prestress of the traction means being necessary to bring about the slip-free drive for starting the internal combustion engine by means of the starter generator. This increased prestressing force of the traction means would, for continuous operation, result in the bearings of the assemblies to be driven and the traction means having to be given larger or stronger dimensions in order to avoid premature failure.

The design according to the invention ensures that the prestress of the traction means is adapted to each operating mode by virtue of the fact that an actuator sets the clamping device in conjunction with a controller. The invention can preferably be used for traction mechanisms with a starter generator and a conventional clamping system in order to be able to implement, for a short starting process, the required prestress of the traction means which is increased for the function of the starter generator.

The invention according to claim 2 relates to a clamping device in which a pivotably arranged assembly, preferably a starter generator, simultaneously performs the function of the clamping device. This component-optimized concept can also be combined with the actuator lever according to the invention which can be adjusted automatically between at least two positions by means of an actuator in conjunction with a controller.

Further advantageous refinements of the invention are the subject-matter of the dependent claims 3 to 17.

For the traction mechanism which includes the drive and the output of a starter generator the invention suggests pivoting the actuating lever between two end positions. This first end position is assigned here to the start mode in which the starter generator drives the internal combustion engine in the start phase. Directly after the start of the internal combustion engine the actuator is actuated automatically triggered by a controller and pivots the actuating lever into an end position which corresponds to the generator mode, with reduced prestress of the traction means occurring simultaneously.

The invention also includes measures which permit multiply stepped adjustment of the actuating lever in conjunction with the actuator. Such multiple adjustment is appropriate, for example, for a traction mechanism which includes assemblies which are not driven continuously but instead in a chronologically limited or periodic fashion such as, for example, an air conditioning system compressor or a coolant pump which can be switched on as a function of demand. In such a context, the actuator or the electronic controller can be actuated as soon as the air conditioning system compressor or the coolant pump starts up in order to increase the prestress of the traction means using the actuating lever and the roller which is directly connected thereto or the starter generator.

The embodiment of the actuating lever provides for it to have at least two supporting faces which are at angles with respect to one another and interact with reference faces or contact faces on a fixedly arranged housing, for example the crank casing of the internal combustion engine. The arrangement of the support faces in accordance with the reference faces permit defined end positions of the actuating lever in two positions.

An electrically driven actuator which includes, for example, a threaded drive is preferably suitable as an actuator with which the actuating lever can be pivoted. The clamping device according to the invention can also be combined with a pneumatically or electro-hydraulically operated actuator. For this purpose, the oil pressure of the lubrication oil circuit of the internal combustion engine can preferably be applied to the actuator, with the actuator being actuated by means of an electrically actuated multi-directional valve.

The controller according to the invention which is connected to the actuator also advantageously includes a signal processing means. For this purpose, for example sensors are arranged on the individual assemblies and they transmit the operating state as a signal to the signal processing means, the electronic controller. In this context the actuator is activated as a function of the operating state or defined operating parameters of the internal combustion engine.

Furthermore, the clamping device according to the invention is configured in such a way that it can be combined with all the customary spring means. For example the helical spring which is designed as a compression spring, a spring-damping element or a hydraulic spring means which includes a prestressed piston whose displacement requires hydraulic fluid compensation between a pressure space and a supply space is suitable as the spring means.

One preferred embodiment of the invention according to claim 1 provides for the roller lever, arranged so as to be pivotable about a rotational axis, of the clamping device to be configured as a triangular base body. Each apex of the base body is assigned one of the components such as a roller, spring means and a rotational axis.

A further advantageous refinement of the actuating lever relates to adapted arrangement of the support faces—which are at an angle to one another—in relation to the reference faces on a fixed housing. In order to obtain stable end positions, these faces are arranged with respect to one another in such a way that an axial offset is set between a coupling point for the spring means and the pivot of the actuating lever irrespective of the end position or position of the actuating lever.

This axial offset is determined by the arrangement of the support faces and of the reference faces. The actuating lever also defines the angle of inclination whose first limb forms a longitudinal axis which connects the coupling point to the pivot, and the support faces of the actuating lever form the second limb.

According to the invention as claimed in claim 1, in one installation position an axial offset is set between the pivot of the roller lever and a coupling point of the spring means at the roller lever irrespective of the position of the roller lever.

### BRIEF DESCRIPTION OF THE DRAWINGS

Two preferred exemplary embodiments, illustrated in four figures, clarify the inventions. In said drawings:

FIG. 1 shows a clamping device according to the invention in a first end position;

FIG. 2 shows the clamping device according to FIG. 1 in an end position which differs from that in FIG. 1;

FIG. 3 shows a traction mechanism in which a pivotably arranged assembly which is supported by a spring means is illustrated in a mounting position; and

FIG. 4 shows the clamping device according to FIG. 3 in the operating position.

### DETAILED DESCRIPTION OF THE DRAWINGS

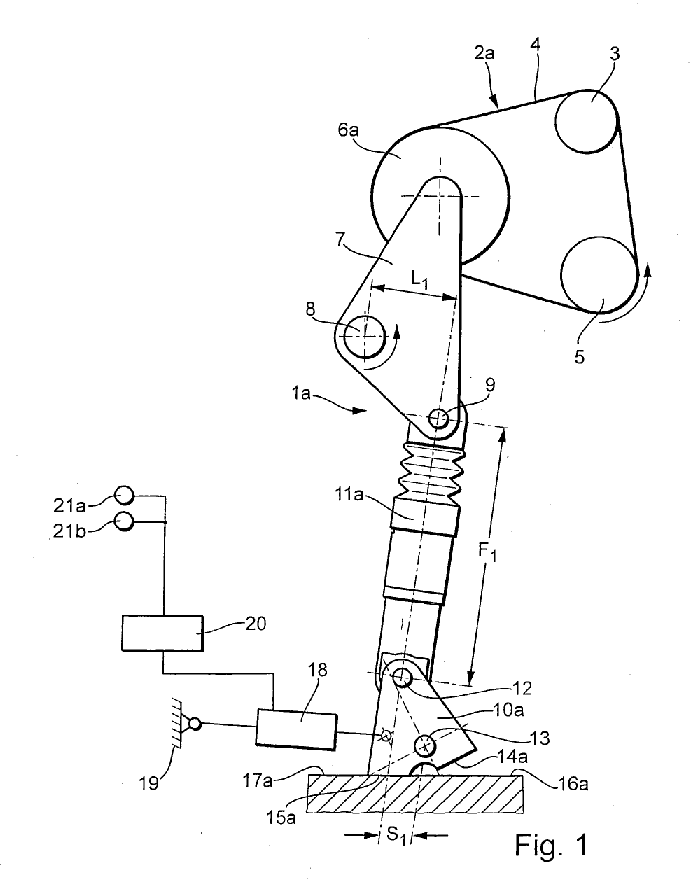

FIG. 1 shows a clamping device la which is assigned to a traction mechanism 2a. The traction mechanism 2a is provided for driving individual assemblies, with the drive element 3 which is represented in FIG. 1 being provided to represent different assemblies such as, for example, a power steering system, air conditioning system compressor or a generator. A traction means 4 encloses, at least in certain areas, the pulley of the drive element 5, of the drive element 3 and of the roller 6a which is connected to the clamping device 1a. The clamping device la comprises a roller lever 7 which is of triangular design and which can be pivoted about a rotational axis 8. Furthermore, at the two other apexes of the roller lever 7 a coupling point 9 for a spring means 11a, embodied as a spring-damping means, and the roller 6a are provided.

The roller 6a is connected to the traction mechanism 2a via the traction means 4. The spring means 11a is connected at one end to the roller lever 7 and at the other end in an articulated fashion to the actuating lever 10a via a coupling point 12. The actuating lever 10a which can pivot between two end positions about the pivot 13 has two support faces 14a, 15a which interact with reference faces 16a, 17a which are assigned to a fixed housing and are also referred to as contact faces. In FIG. 1, the actuating lever 10a is supported by means of the support face 15a on the reference face 17a and thus defines a first end position which corresponds to the clamping device 1a. In this context, a stress-relieved position of the traction means 4 is set and in this position the traction means 4 can easily be mounted. In order to obtain a stable end position, an axial offset “S₁” is formed between the pivot 13 and the coupling point 12 of the actuating lever 10a. The pivoting region of the roller 6a during an adjustment of the actuating lever 10a is influenced by the arrangement of the rotational axis 8 with respect to the coupling point 9 of the roller lever 7, characterized by the axial offset “L₁”.

The actuating lever 10a is pivoted by means of an actuator 18. The latter component, also referred to as an actuator, is supported by one end on a fixed component and attached in a mutually articulated fashion to the actuating lever 10a. In order to bring about automatic adjustment of the actuating lever 10a between the two end positions, a controller 20, by means of which, for example, prestress of the traction means 4 in the traction mechanism 2a can be influenced is assigned to the actuator 18. For this purpose, the controller 20 comprises sensors 21a, 21b via which the actuating lever 10a is adjusted, for example as a function of an operating state of a drive element 3 or an operating parameter of the internal combustion engine.

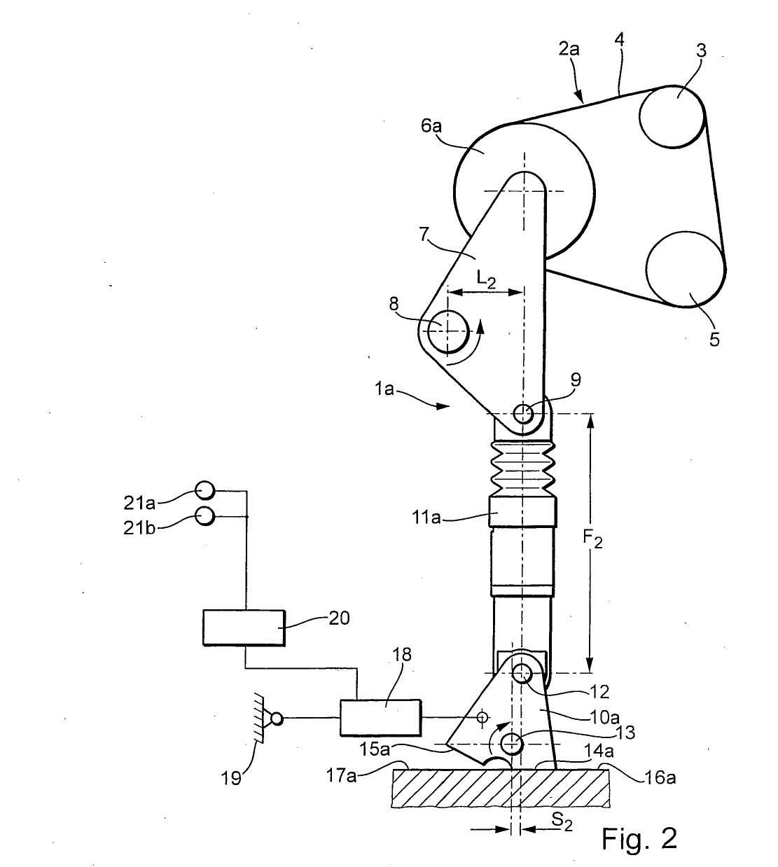

FIG. 2 shows the actuating lever 10a of the clamping device 1a in the second end position. In this position of the actuating lever 10a, reduced axial distances “S₂; L₂” are obtained compared to the corresponding axial distances in the first end position, illustrated in FIG. 1. At the same time, the length “F₁, F₂” of the spring means 11a between the two end positions of the clamping device 1a changes, as a result of which a different clamping force is set. The second end position is brought about by activating the actuator 18 which pivots the actuating lever 10a in the clockwise direction into the second end position. As a result, the rotation of the roller lever 7 in the counterclockwise direction is triggered, causing the roller 6 which is connected to the roller lever 7 to assume a position in which the greater degree of prestress of the traction means 4 is set. FIG. 2 shows the traction means 4 in the state in which it is prestressed to a maximum degree by the clamping device 1a. This may correspond, for example, to the start mode of a drive element 3 which is configured as a starter generator in order to ensure slip-free drive and thus starting of the internal combustion engine by the starter generator. In the start mode, the roller 6a is arranged in the pulling strand in a traction mechanism 2a which circulates in the clockwise direction. The arrangement of the roller 6a in the pulling strand of the traction means 4 requires a greater degree of prestress of the traction means 4 in order to achieve slip-free drive of the drive element 3 which is configured as a starter generator onto the other assemblies or the crankshaft, drive element 5. After the internal combustion engine starts, all the assemblies which are connected to the traction mechanism 2a are driven by the drive element 5 which is connected to the internal combustion engine. In synchronism with this, the actuator 18 which pivots the actuating lever 10a into the end position represented in FIG. 1 is actuated by means of the controller 20, with the roller 6a moving simultaneously in the clockwise direction, connected to a reduced prestress of the traction means 4.

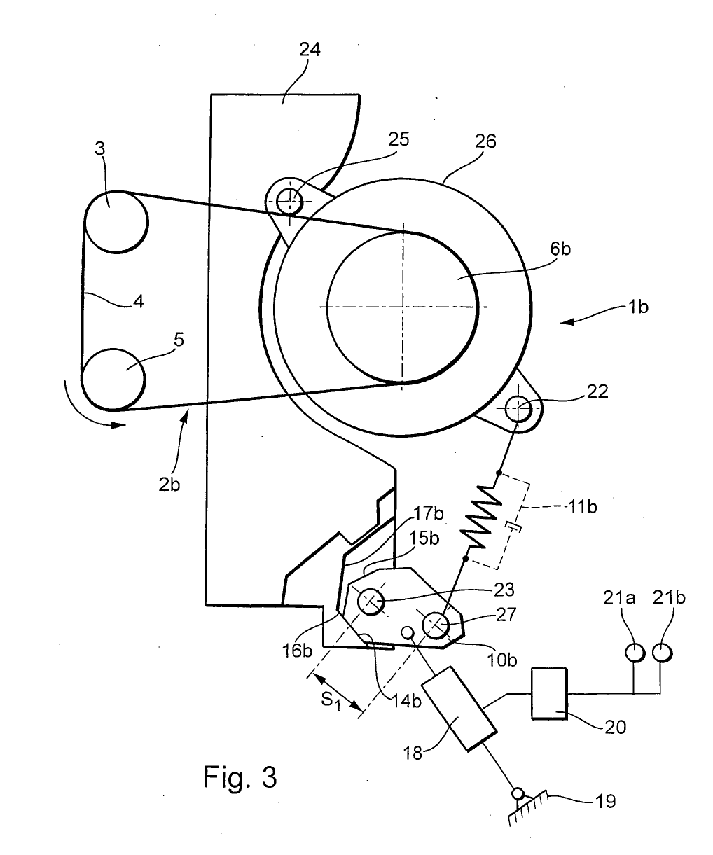

FIG. 3 shows the traction mechanism 2b in conjunction with the clamping device 1b which includes a pivotably arranged assembly, a starter generator 26. The belt-driven starter generator 26 has a roller 6b which is operatively connected via the traction means 4 of the traction mechanism 2b to the drive element 3 and to the output element 5. The prestress of the traction means 4 can be influenced by pivoting the clamping device 1b, i.e. the starter generator 26, about the rotational axis 25. A spring means 11b, which is also connected to the actuating lever 10b via the articulation point 27, is arranged on the starter generator 26 at the coupling point 22, in an offset position with respect to the rotational axis 25.

In order to activate the actuating lever 10b, an actuator 18 is provided in conjunction with a controller 20. Two operating states are provided for the starter generator 26. In the start mode, the starter generator 26 carries out the function of a starter in that the starter generator 26 drives the internal combustion engine until it starts. When the internal combustion engine is running, the generator mode of the starter generator 26 is set, with the starter generator 26 being driven by the internal combustion engine. Irrespective of the operating mode of the starter generator 26, the sense of rotation of the traction mechanism 2b remains the same. FIG. 3 shows the traction mechanism 2b in the generator mode of the starter generator 26. For this purpose, the actuating lever 10b is supported on the reference face 16b of the housing 24 by means of the support face 14b, with an axial offset “S₁” being set between the articulation point 22 and the pivot 23 of the actuating lever 10b.

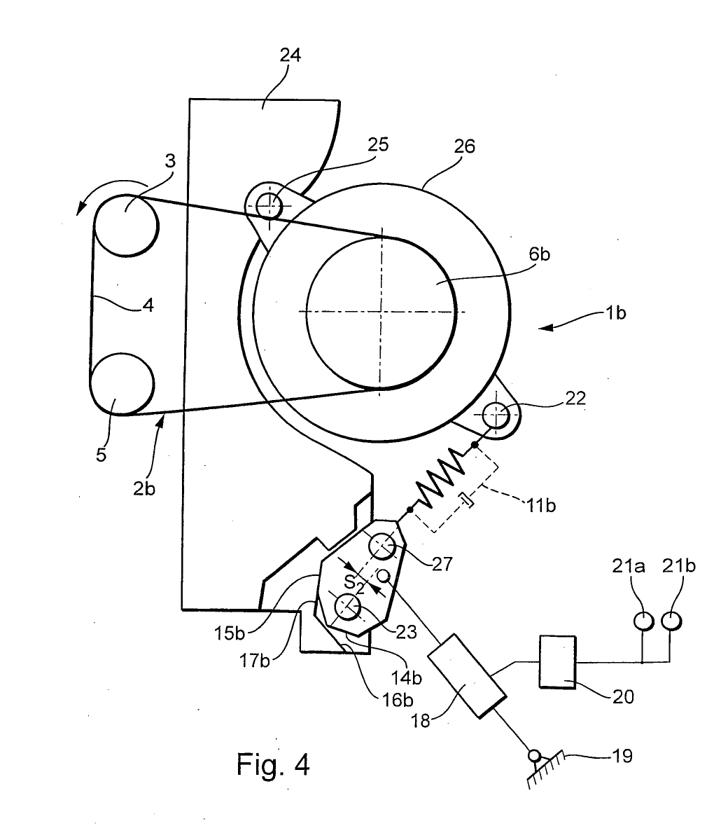

FIG. 4 shows a traction means 4 which is prestressed to a maximum degree. For this purpose, the actuating lever 10b is pivoted in the counterclockwise direction into the second end position by means of the actuator 18, in which second end position the support face 15b of the actuating lever 10b is supported on the reference face 17b of the housing 24. In synchronism with this movement of the actuating lever 10b, the clamping device 1b is rotated in the counterclockwise direction, as a result of which the traction means 4 is prestressed to a maximum degree. The clamping device 1b comprises a spring means 11b which is configured as a spring-damper unit, in order to obtain a clamping device 1b which is arranged in a way which is as free of vibration as possible.

### LIST OF REFERENCE NUMERALS

1a Clamping device
1b Clamping device
2a Traction mechanism
2b Traction mechanism
3 Drive element
4 Traction means
5 Output element
6a Roller
6b Roller
7 Roller lever
8 Rotational axis
9 Articulation point
10a Actuating lever
10b Actuating lever
11a Spring means
11b Spring means
12 Articulation point
13 Pivot
14a Support face
14b Support face
15a Support face
15b Support face
16a Reference face
16b Reference face
17a Reference face
17b Reference face
18 Actuator
19 Component
20 Controller
21a Sensor
21b Sensor
22 Articulation point
23 Pivot
24 Housing
25 Rotational axis
26 Starter generator
27 Articulation point
F₁, F₂ Length of the spring means 11a
L₁, L₂ Axial offset between the rotational axis 8 and the articulation point 9 of the roller lever 7
S₁, S₂ Axial offset between the articulation point 12 and the pivot 13 of the actuating lever 10a, 10b

1. A clamping device, for a traction means (4) of a traction mechanism (2a) whose rotatably mounted roller (6a) which is connected to a spring means (11a) bears in a frictionally locking fashion against the traction means (4), the traction mechanism (2a) which is assigned to an internal combustion engine including a drive and an output of a starter generator (26), characterized in that the clamping device (1a) is assigned a pivotable roller lever (7) which is supported on a spring means (11a) and on which the roller (6a) is positioned, and the spring means (11a) is also connected to an actuating lever (10a) which, by means of an actuator (18) in conjunction with a controller (20), pivots the actuating lever (10a) between at least two positions, as a function of an operating state and/or at least one operating parameter of the internal combustion engine.

2. The clamping device which prestresses a traction means (4) of a traction mechanism (2b), a rotatably mounted assembly which is supported by a spring means (11b) being provided as a clamping device (1b) and its roller (6b) bearing in a frictionally locking fashion against the traction means (4), the traction drive (2b) which is assigned to the internal combustion engine including a drive and output of the starter generator (26), characterized in that the spring means (11b) is connected at one end to the starter generator (26) and at the other end to a pivotably arranged actuating lever (10b), an actuator (18) pivoting, in conjunction with a controller (20), the actuating lever (10b) automatically between at least two positions or end positions as a function of an operating state and/or at least an operating parameter of the internal combustion engine.

3. The clamping device as claimed in claim 1 or as claimed in claim 2, the actuating lever (10a, 10b) being pivotable between a first position, corresponding to a starting mode, and a second position, corresponding to a generator mode, of the starter generator (26).

4. The clamping device as claimed in claim 1, the actuator (18) pivoting the actuating lever (10a) between a plurality of positions which are determined as a function of the operating state of individual assemblies and/or operating parameters of the internal combustion engine.

5. The clamping device as claimed in claim 1 or as claimed in claim 2 which has an actuating lever (10a, 10b) with two support faces (14a, 14b; 15a, 15b) which are at an angle with respect to one another and which, in conjunction with reference faces (16a, 16b; 17a, 17b) of a housing (24) of the internal combustion engine, ensure defined end positions of the actuating lever (10a, 10b).

6. The clamping device as claimed in claim 1 or as claimed in claim 2, the actuating lever (10a, 10b) being adjustable by means of an electrically actuated actuator (18).

7. The clamping device as claimed in claim 1 or as claimed in claim 2, the clamping lever (10a, 10b) of which interacts with a pneumatically acting actuator (18).

8. The clamping device as claimed in claim 1 or as claimed in claim 2, a hydraulically acting or electro-hydraulically acting actuator (18) adjusting the actuating lever (10a, 10b).

9. The clamping device as claimed in claim 8, in which, for the purpose of hydraulic actuation, a lubricant circuit or a pressurized circulation lubrication system of the internal combustion engine acts on the actuator (18) and triggers adjustment of the actuating lever (10a, 10b) in conjunction with the controller (20).

10. The clamping device as claimed in claim 1 or as claimed in claim 2, the control process (20) of which includes signal processing with at least one sensor (21a, 21b) which actuates the actuator (18) as a function of operating states of an assembly and/or operating parameters of the internal combustion engine.

11. The clamping device as claimed in claim 2, with a spring-damper unit being used as the spring means (11b).

12. The clamping device as claimed in claim 1, to which a hydraulically acting spring means (11a) is assigned.

13. The clamping device as claimed in claim 1, the roller lever (7) of the clamping device (1a) being pivotable about a rotational axis (8) on which the rotatable roller (6a) which is assigned to the traction means (4) is positioned.

14. The clamping device as claimed in claim 13, each apex of the triangular roller lever (7) being assigned in each case one of the components of the roller (6a) spring means (11a) and rotational axis (8).

15. The clamping device as claimed in claim 1 or as claimed in claim 2, in which an offset “S₁, S₂” occurs between an articulation point (12, 22) for the spring means (11a, 11b) and a pivot (13, 23) of the actuating lever (10a, 10b) irrespective of the end position or position of the actuating lever (10a, 10b).

16. The clamping device as claimed in claim 1 or as claimed in claim 2, an angle of inclination which influences the offset “S₁, S₂” between the articulation point (12, 22) and the pivot (13, 23) of the actuating lever (10a, 10b) being set between the support faces (14a, 14b; 15a, 15b) of the actuating lever (10a, 10b) and the reference faces (16a, 16b; 17a, 17b) of the housing (24).

17. The clamping device as claimed in claim 1, an axial offset “L₁, L₂” being set between the rotational axis (8) and the articulation point (9) for the spring means (11a) irrespective of the position of the roller lever (7).
